(19) United States
(12) Patent Application Publication
(10) Pub. No.: US 2014/0064328 A1
(43) Pub. Date: Mar. 6, 2014

(54) THERMOMETER ELECTROMAGNETIC SENSOR WAVEGUIDE

(71) Applicant: Jason Roth, Boca Raton, FL (US)

(72) Inventor: Jason Roth, Boca Raton, FL (US)

(73) Assignee: BROOKLANDS, INC., Boca Raton, FL (US)

(21) Appl. No.: 13/864,475

(22) Filed: Apr. 17, 2013

Related U.S. Application Data
(63) Continuation of application No. 13/597,173, filed on Aug. 28, 2012.

(51) Int. Cl. G01J 5/08

(52) U.S. Cl. CPC G01J 5/08
USPC 374/130

(57) ABSTRACT

Systems, methods and apparatus are provided through which in some implementations a non-contact thermometer includes a square-angled waveguide.

### RELATED APPLICATION

This application claims priority under 35 U.S.C. 120 to copending U.S. application Ser. No. 13/597,173 filed 25 SEPT 2012 entitled “THERMOMETER ELECTROMAGNETIC SENSOR WAVEGUIDE.”

### BACKGROUND

1. Field

This disclosure relates generally to digital thermometers, and more particularly to sensor waveguides of non-contact thermometers.

2. Description of Related Art

Conventional non-contact digital thermometers have funnel-shaped sensor waveguides.

### BRIEF DESCRIPTION

In one aspect, an apparatus to measure temperature includes a housing, at least one printed circuit board mounted in the housing, a non-contact-thermometer operably coupled to the at least one printed circuit board, the non-contact-thermometer having an infrared sensor, the infrared sensor being operable to receive infrared energy via a pathway to the infrared sensor, a lens positioned over the pathway to the infrared sensor, the lens having only right-angled edges, the lens being square in geometry, that is transverse to the pathway to the infrared sensor, wherein the pathway intersects the lens, a reflector that is positioned at a 45 degree angle to the infrared sensor, the lens having a longitudinal axis that is transverse to a longitudinal axis of the infrared sensor, and the reflector being positioned at a 45 degree angle to the lens, a waveguide in the housing between the lens and the at least one printed circuit board, the waveguide having at least one right-angle, a display device operably coupled to the at least one printed circuit board, a button operably coupled to the at least one printed circuit board and a battery operably coupled to the at least one printed circuit board.

In another aspect, an apparatus to measure temperature includes a housing, at least one printed circuit board mounted in the housing, a non-contact-thermometer operably coupled to the at least one printed circuit board, the non-contact-thermometer having an electromagnetic sensor, the electromagnetic sensor being operable to receive electromagnetic energy via a pathway to the electromagnetic sensor, a lens positioned over the pathway to the electromagnetic sensor, the lens having at least one right-angled edge, a display device operably coupled to the at least one printed circuit board, a button operably coupled to the at least one printed circuit board, a battery operably coupled to the at least one printed circuit board.

In yet another aspect, An apparatus to measure temperature including at least one printed circuit board, a non-contact-thermometer operably coupled to the at least one printed circuit board, the non-contact-thermometer having an electromagnetic sensor, the electromagnetic sensor being operable to receive electromagnetic energy via a pathway to the electromagnetic sensor, a waveguide to the electromagnetic sensor, the waveguide having at least one right-angle, the right-angle reflecting electromagnetic energy to the electromagnetic sensor that is about the energy level of the electromagnetic sensor outside the waveguide, a display device operably coupled to the at least one printed circuit board, a button operably coupled to the at least one printed circuit board, a battery operably coupled to the at least one printed circuit board, a contact-thermometer operably coupled to the at least one printed circuit board, yielding a sensed temperature, a color display device operably coupled to the at least one printed circuit board, wherein the color display device activates pixels in at least two colors, the colors being in accordance with the sensed temperature.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of apparatus to measure temperature, according to an implementation;

FIG. 2 is an isometric top-view block diagram of an apparatus to measure temperature using both a non-contact thermometer with a right-angled waveguide and not including a contact thermometer, according to an implementation;

FIG. 3 is a side-view block diagram of an apparatus to measure temperature using a non-contact thermometer with a right-angled waveguide, according to an implementation;

FIG. 4 is an isometric block diagram of an apparatus to measure temperature using both non-contact thermometer with a right-angled waveguide and contact thermometer, according to an implementation;

FIG. 5 is a block diagram of apparatus to measure temperature, according to an implementation in which each of a non-contact thermometer and a contact thermometer are controlled by a separate printed circuit board and the non-contact thermometer has a right-angled waveguide, according to an implementation;

FIG. 6-12 are block diagrams of a sensor collector to guide electromagnetic energy to measure temperature, according to an implementation;

FIG. 13-18 are block diagrams of a shroud of a sensor collector to guide electromagnetic energy to measure temperature, according to an implementation;

FIG. 19 is a representation of display that is presented on the display device of apparatus in FIG. 1-5, according to an implementation that manages both a non-contact-thermometer and a contact-thermometer;

FIG. 20 is a representation of display that is presented on the display device of apparatus in FIG. 1-5, according to an implementation;

FIG. 21 is a representation of text displays that are presented on the display device of apparatus in FIG. 1-5, according to an implementation;

FIG. 22-27 are representations of graphical displays that are presented on the display device of apparatus in FIG. 1-5, according to implementations;

FIG. 28 is a flowchart of a method to display temperature color indicators, according to an implementation;

FIG. 29 is a flowchart of a method to display temperature color indicators, according to an implementation of three colors;

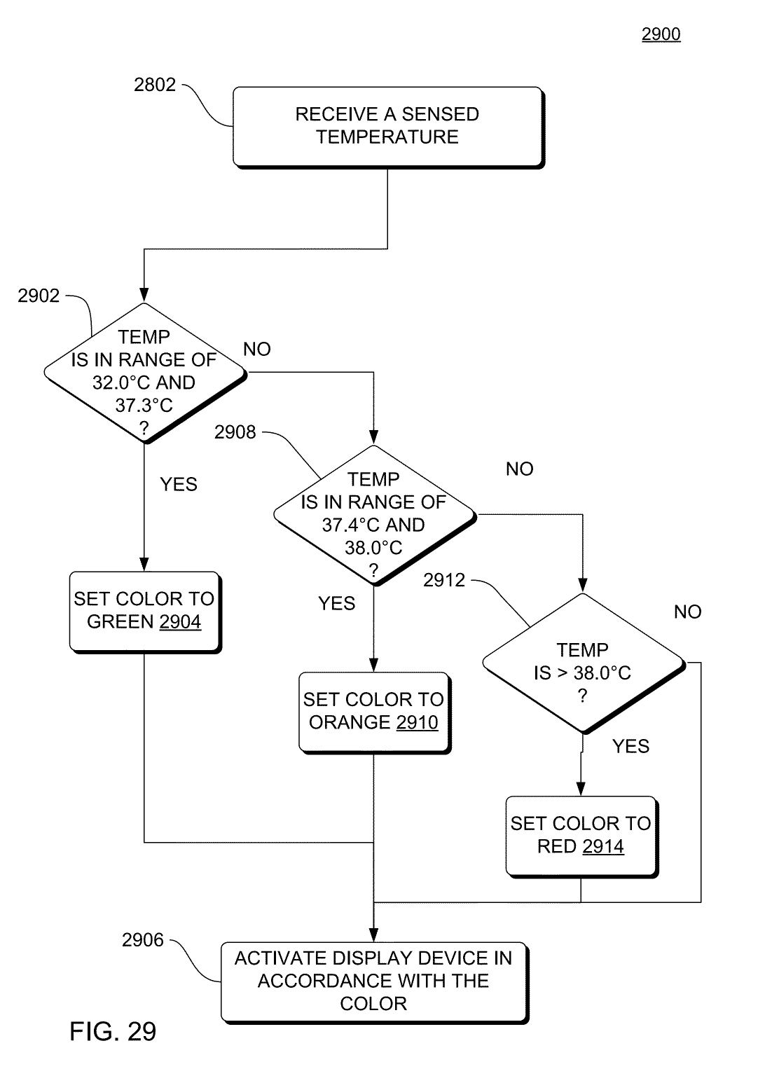

FIG. 30 is a block diagram of a thermometer control computer, according to an implementation; and

FIG. 31 is a block diagram of a data acquisition circuit of a thermometer control computer, according to an implementation.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into four sections. In the first section, apparatus of implementations are described. In the second section, implementations of methods are described. In the third section, a hardware and the operating environment in conjunction with which implementations may be practiced are described. Finally, in the fourth section, a conclusion of the detailed description is provided.

### Apparatus Implementations

In this section, particular apparatus of implementations are described by reference to a series of diagrams.

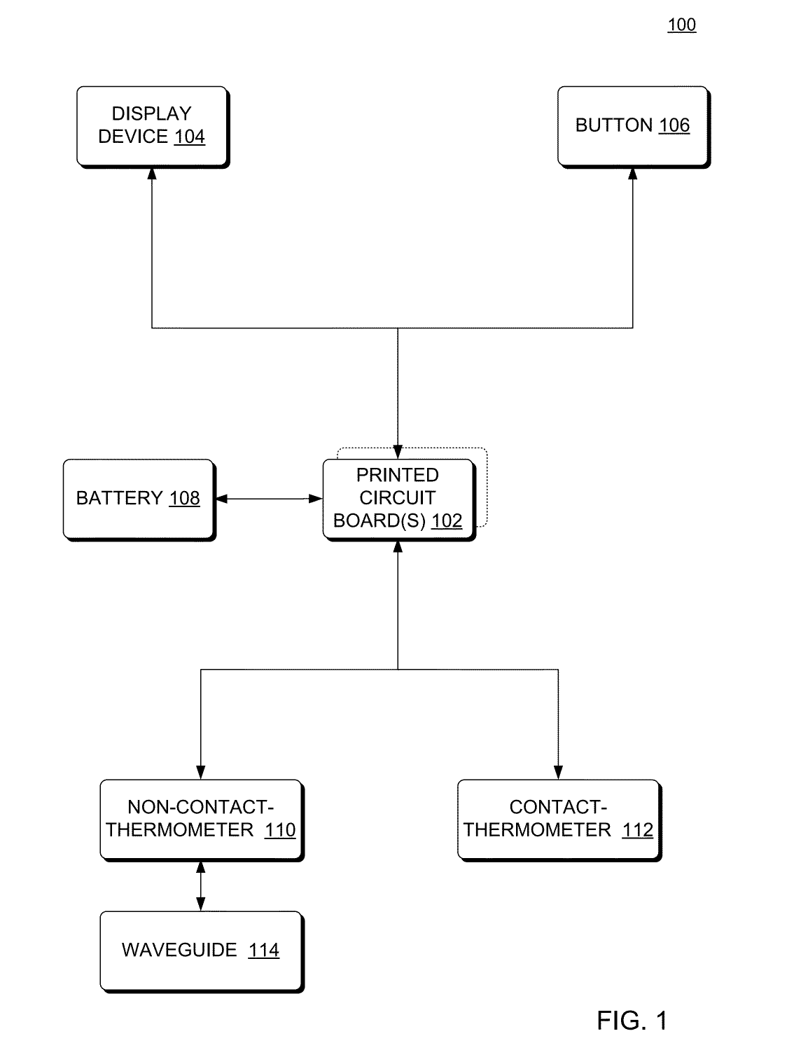

FIG. 1 is a block diagram of apparatus 100 to measure temperature, according to an implementation. Apparatus 100 is handheld and battery powered for intermittent measurement and monitoring of human or animal body temperature of people of all ages. Apparatus 100 measures both electromagnetic energy emitted from the skin surface, such as infrared energy, of the human or animal and direct body temperature. Apparatus 100 is operationally simple enough to be used by consumers in the household environment, yet accurate enough to be used by professional medical facilities.

Apparatus 100 includes one or more printed circuit board(s) 102.

Apparatus 100 also includes a display device 104 that is operably coupled to the one or more printed circuit board(s) 102. Some implementations of apparatus 100 also include a button 106 that is operably coupled to the one or more printed circuit board(s) 102. Apparatus 100 also includes a battery 108, such as a lithium ion battery, that is operably coupled to the one or more printed circuit board(s) 102.

Apparatus 100 also includes a non-contact-thermometer 110 that is operably coupled to the one or more printed circuit board(s) 102. The non-contact-thermometer 110 detects temperature in response to remote sensing of a surface a human or animal. In some implementations the non-contact thermometer is an infrared temperature sensor. All humans or animals radiate infrared energy. The intensity of this infrared energy depends on the temperature of the human or animal, thus the amount of infrared energy emitted by a human or animal can be interpreted as a proxy or indication of the temperature of the human or animal. The non-contact-thermometer 110 measures the temperature of a human or animal based on the electromagnetic energy radiated by the human or animal. The measurement of electromagnetic energy is taken by the non-contact-thermometer 110 which constantly analyzes and registers the ambient temperature. When the operator of apparatus 100 holds the non-contact-thermometer 110 about 5-8 cm (2-3 inches) from the forehead and activates the radiation sensor, the measurement is instantaneously measured. To measure a temperature using the non-contact-thermometer 110, pushing the button 106 causes a reading of temperature measurement from the non-contact-thermometer 110 and the measured temperature is thereafter displayed on the display device 104.

Body temperature of a human or animal can be measured in many surface locations of the body. Most commonly, temperature measurements are taken of the forehead, mouth (oral), inner ear (tympanic), armpit (axillary) or rectum. An ideal place to measure temperature is the forehead. The apparatus 100 also detects the body temperature of a human or animal regardless of the room temperature because the measured temperature of the non-contact-thermometer 110 is adjusted in reference to the ambient temperature in the air in the vicinity of the apparatus. The human or animal must not have undertaken vigorous physical activity prior to temperature measurement in order to avoid a misleading high temperature. Also the room temperature should be moderate, 50° F. to 120° F.

The non-contact thermometer 110 provides a non-invasive and non-irritating means of measuring human or animal temperature to help ensure good health or to ensure that a baby's bottle is not too warm or too cold.

Some implementations of apparatus 100 also include a contact-thermometer 112 that is operably coupled to the one or more printed circuit board(s) 102. The contact-thermometer 112 detects temperature in response to direct contact with a human or animal.

A right-angled waveguide 114 is positioned in proximity to the non-contact thermometer 110. The geometry of the right-angled waveguide 114 has at least one right-angle and at least flat planar surface. In some implementations, the geometry of the right-angled waveguide 114 has only right-angled edges. In general, a waveguide is a structure of a passageway or pathway which guides waves, such as electromagnetic waves. Waves in open space propagate in all directions, as spherical waves. In this way the wave lose power proportionally to the square of the distance; that is, at a distance R from the source, the power is the source power divided by R2. The waveguide confines the wave to propagation in one dimension, so that (under ideal conditions) the wave loses no power while propagating. Waves are confined inside the waveguide due to total reflection from the waveguide wall, so that the propagation inside the waveguide can be described approximately as a “zigzag” between the walls. There are different types of waveguides for each type of wave. The original and most common implementation of a waveguide is a hollow conductive metal pipe used to carry high frequency radio waves, particularly microwaves. Waveguides differ in their geometry which can confine energy in one dimension such as in slab waveguides or a waveguide can confine energy in two dimensions as in fiber or channel waveguides. As a rule of thumb, the width of a waveguide needs to be of the same order of magnitude as the wavelength of the guided wave.

A conventional geometry of a waveguide has a circular cross-section, which is most useful for gathering electromagnetic waves that have a rotating, circular polarization in which the electrical field traces out a helical pattern as a function of time. However, infrared energy emitted from a surface of a human does not have a rotating, circular polarization in which the electrical field traces out a helical pattern as a function of time. Therefore, in apparatus that measures infrared energy of a human as a proxy of temperature of the human, circular and rounded waveguides should not be used. The waveguide 114 is not conical in geometry because a conical waveguide reflects the electromagnetic waves in a somewhat incoherent manner in which the electromagnetic waves are received at the sensor with a decreased degree of coherency, thus decreasing the signal strength; and the conical waveguide reflects a significant portion of electromagnetic waves out of the waveguide and away from the sensor, thus further reducing the signal strength of the electromagnetic waves received by the sensor and therefore further reducing the accuracy and speed of the non-contact temperature sensing. More specifically, waveguide 114 is not a conical funnel in which the conical funnel has an opening at one end of a longitudinal axis that has a larger diameter than an opening at the other end of the longitudinal axis.

The dual thermometers 110 and 112 provide improved convenience and heightened accuracy in detecting temperatures in humans or animals. In some situations, the non-contact thermometer 110 is used as an initial instrument of temperature detection of a human or animal and the contact-thermometer 112 is used as a second instrument of temperature detection of the human or animal. The non-contact-thermometer 110 eliminates need for contact with the skin, yet the contact-thermometer 112 provides a more accurate detection of human or animal body temperature to supplement or verify the temperature detected by the non-contact thermometer 110.

In some implementations, the apparatus 100 includes only one printed circuit board 102, in which case the printed circuit board 102 includes not more than one printed circuit board 102. In some implementations, the apparatus 100 includes two printed circuit boards 102, such as a first printed circuit board and a second printed circuit board. In some implementations, the printed circuit board(s) 102 include a microprocessor. In some implementations, the apparatus 100 includes only one display device 104, in which case the display device 104 includes not more than one display device 104. In some implementations, the display device 104 is a liquid-crystal diode (LCD) display device. In some implementations, the display device 104 is a light-emitting diode (LED) display device. In some implementations, the apparatus 100 includes only one battery 108, which case the battery 108 includes not more than one battery 108.

When evaluating results, the potential for daily variations in temperature can be considered. In children less than 6 months of age daily variation is small. In children 6 months to 2 years old the variation is about 1 degree. By age 6 variations gradually increase to 2 degrees per day. In adults there is less body temperature variation.

While the apparatus 100 is not limited to any particular printed circuit board(s) 102, display device 104, button 106, battery 108, non-contact-thermometer 110 and a contact-thermometer 112, for sake of clarity a simplified printed circuit board(s) 102, display device 104, button 106, battery 108, non-contact-thermometer 110 and a contact-thermometer 112 are described.

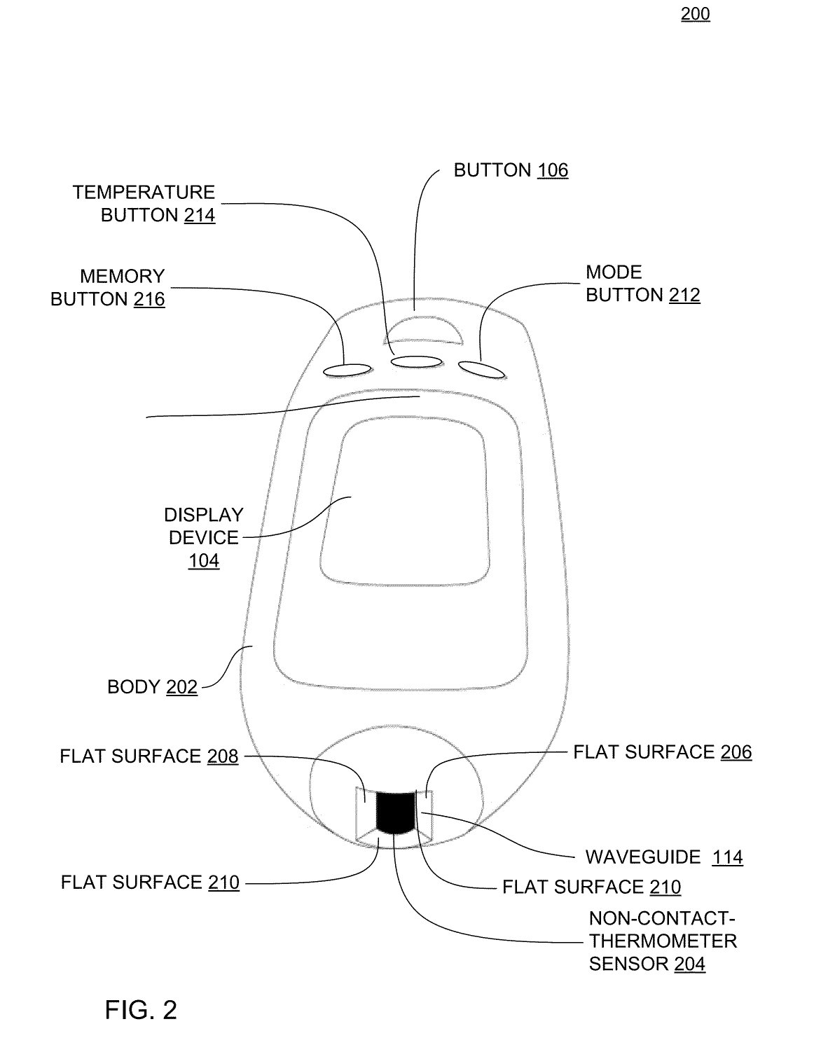

FIG. 2 is an isometric top-view block diagram of an apparatus 200 to measure temperature using both a non-contact thermometer with a right-angled waveguide and not including a contact thermometer, according to an implementation. Apparatus 200 is handheld and battery powered for intermittent measurement and monitoring of human or animal body temperature of people of all ages. Apparatus 200 measures non-contact infrared energy emitted from the skin surface of the human or animal. Apparatus 200 can be used by consumers in the household environment.

Apparatus 200 includes the display device 104 that is mounted on the exterior of a body 202 or other housing of the apparatus 200. Apparatus 200 also includes the button 106 that is mounted on the exterior of the body 202 or other housing of the apparatus 200. Apparatus 200 also includes a sensor 203 of the non-contact-thermometer 110, the sensor 203 being mounted in the interior of the body 202 of the apparatus 200. The non-contact-thermometer 110 detects temperature in response to remote sensing of a surface a human or animal. The right-angled waveguide 114 is positioned in proximity to the sensor 204. The right-angled waveguide 114 includes at least one flat planar surface. The apparatus 200 includes 4 flat planar surfaces 206, 208, 210 and 212.

Apparatus 200 also includes a mode button 212 that when pressed by an operator toggles or switches between three different detection modes, a first detection mode being detection and display of surface temperature, a second detection mode being detection and display of body temperature and a third detection mode being detection and display of room temperature.

Apparatus 200 also includes a temperature button 214 that when pressed by an operator toggles or switches between two different temperature modes, a first temperature mode being display of temperature in Celsius and a second temperature mode being display of temperature in Fahrenheit.

Apparatus 200 also includes a memory button 216 that when pressed by an operator toggles or switches between a plurality of past temperature readings. In one implementation, the plurality of past temperature readings is 32.

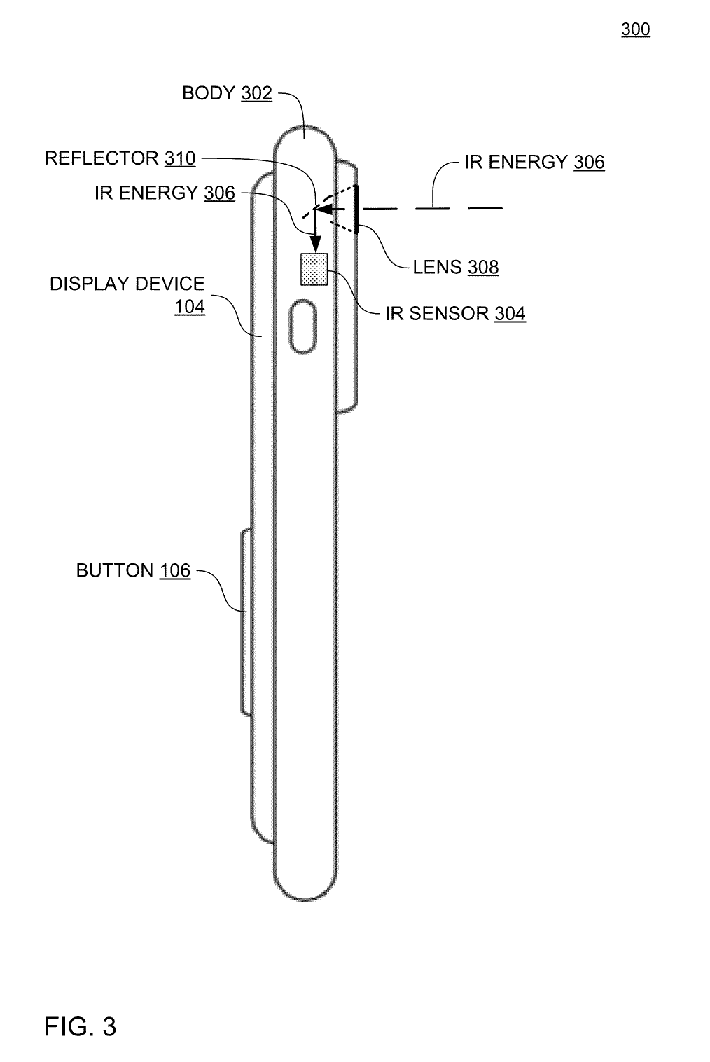

FIG. 3 is a side-view block diagram of an apparatus 300 to measure temperature using a non-contact thermometer with a right-angled waveguide, according to an implementation. Apparatus 300 is handheld and battery powered for intermittent measurement and monitoring of human or animal body temperature of people of all ages. Apparatus 300 measures non-contact infrared energy emitted from the skin surface of the human or animal. Apparatus 300 can be used by consumers in the household environment.

Apparatus 300 includes the display device 104 that is mounted on the exterior of a body 302 or other housing of the apparatus 300. Apparatus 300 also includes the button 106 that is mounted on the exterior of the body 302 or other housing of the apparatus 300.

Apparatus 300 includes the non-contact-thermometer having an infrared sensor 304. The infrared sensor 304 is operable to receive infrared energy 306 via a pathway to the infrared sensor 304. Apparatus 300 includes a lens 308 that is positioned over the pathway. In some implementations, the lens 308 has only right-angled edges, the lens 308 being square in geometry, that is transverse to the pathway to the infrared sensor 306. The pathway intersects the lens 308. A reflector 310 that is positioned at a 45 degree angle to the infrared sensor 304. The lens 308 has a longitudinal axis that is perpendicular to a longitudinal axis of the infrared sensor. The reflector 310 is positioned at a 45 degree angle to the lens 304. The pathway is coincident to the IR energy 306 that passes through the lens 308, reflects off of the reflector 310 and to the IR sensor 304.

Apparatus 300 also includes the sensor 203 of the non-contact-thermometer 110, the sensor 203 being mounted in the interior of the body 202 of the apparatus 300. The non-contact-thermometer 110 detects temperature in response to remote sensing of a surface of a human or animal. The contact-thermometer 112 detects temperature in response to direct contact with the human or animal. The dual thermometers 110 and 112 provide improved convenience and heightened accuracy in detecting temperatures in humans or animals. In some situations, the non-contact thermometer 110 is used as initial instrument of temperature detection of a human or animal and the contact-thermometer 112 is used as a second instrument of temperature detection of the human or animal.

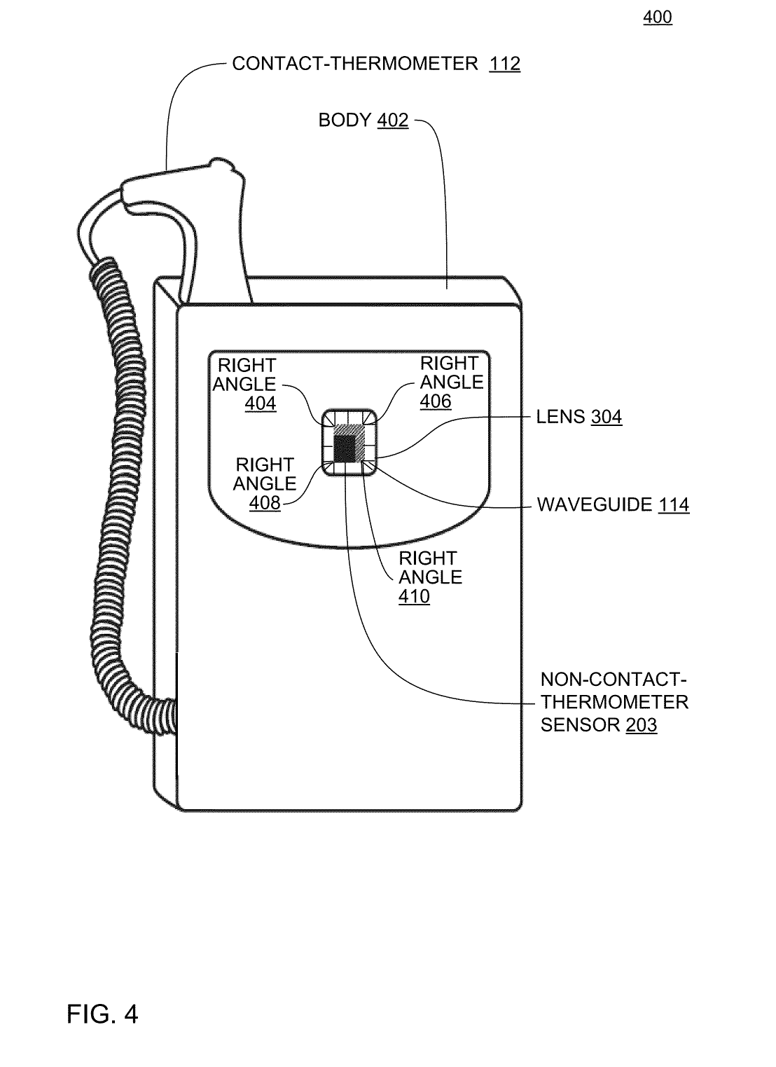

FIG. 4 is an isometric block diagram of an apparatus 400 to measure temperature using both non-contact thermometer with a right-angled waveguide and a contact thermometer, according to an implementation. Apparatus 400 is handheld and battery powered for intermittent measurement and monitoring of human or animal body temperature of people of all ages. Apparatus 400 measures both infrared energy emitted from the skin surface of the human or animal and direct body temperature. Apparatus 400 can be used by consumers in the household environment.

Apparatus 400 includes the display device 104 that is mounted on the exterior of a body 402 of the apparatus 400. Apparatus 400 also includes the button 106 that is mounted on the exterior of the body 402 of the apparatus 400. Apparatus 400 also includes a lens 304 of the non-contact-thermometer 110, the lens 304 being mounted on the exterior of the body 402 of the apparatus 400. The non-contact-thermometer 110 behind the lens 404 detects temperature in response to remote sensing of a surface a human or animal. A right-angled waveguide 114 is positioned in proximity to the non-contact thermometer 110. The right-angled waveguide 114 includes at least one flat planar surface and right angles 404, 406, 408 and 410. Apparatus 400 also includes the contact-thermometer 112 that is mounted on the exterior of the body 402 of the apparatus 400. The contact-thermometer 112 detects temperature in response to direct contact with the human or animal. The dual thermometers 110 and 112 provide both convenience and heightened accuracy in detecting temperatures in humans or animals. In some situations, the non-contact thermometer 110 is used as an initial instrument of temperature detection of a human or animal and the contact-thermometer 112 is used as a second instrument of temperature detection of the human or animal.

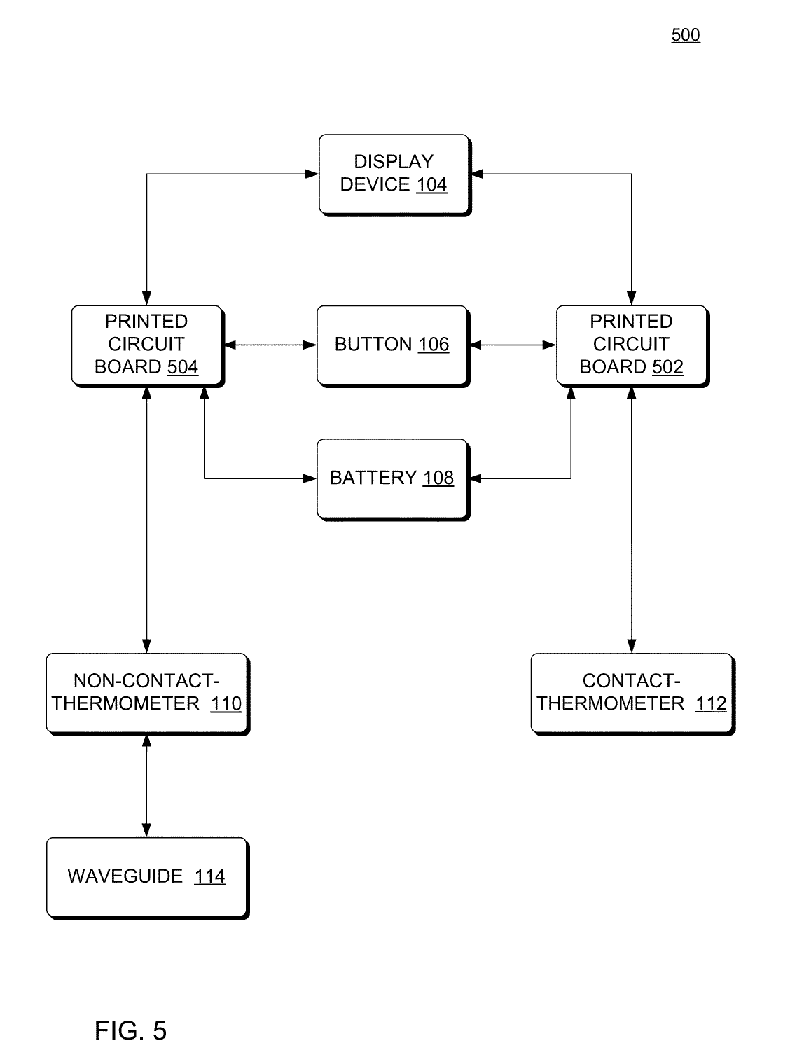

FIG. 5 is a block diagram of apparatus 500 to measure temperature, according to an implementation in which each of a non-contact thermometer and a contact thermometer are controlled by a separate printed circuit board and the non-contact thermometer has a right-angled waveguide, according to an implementation.

Apparatus 500 includes the contact-thermometer 112 that is operably coupled to a first printed circuit board 502, a non-contact-thermometer 110 that is operably coupled to a second printed circuit board 504, the display device 104 that is operably coupled to the first printed circuit board 502 and the second printed circuit board 504, the button 106 that is operably coupled to the first printed circuit board 502 and the second printed circuit board 504 and the battery 108 that is operably coupled to the first printed circuit board 502 and the second printed circuit board 504. In apparatus 500, the display device 104, the button 106 and the battery 108 are shared, but each thermometer has a dedicated printed circuit board.

A right-angled waveguide 114 is positioned in proximity to the non-contact thermometer 110. The geometry of the right-angled waveguide 114 has at least one right-angle. In some implementations, the geometry of the right-angled waveguide 114 has only right-angled edges.

Some implementations of apparatus in FIG. 1-5 include an ambient air temperature sensor that is operably coupled to, or a part of, the printed circuit board(s) 102, 502 or 504.

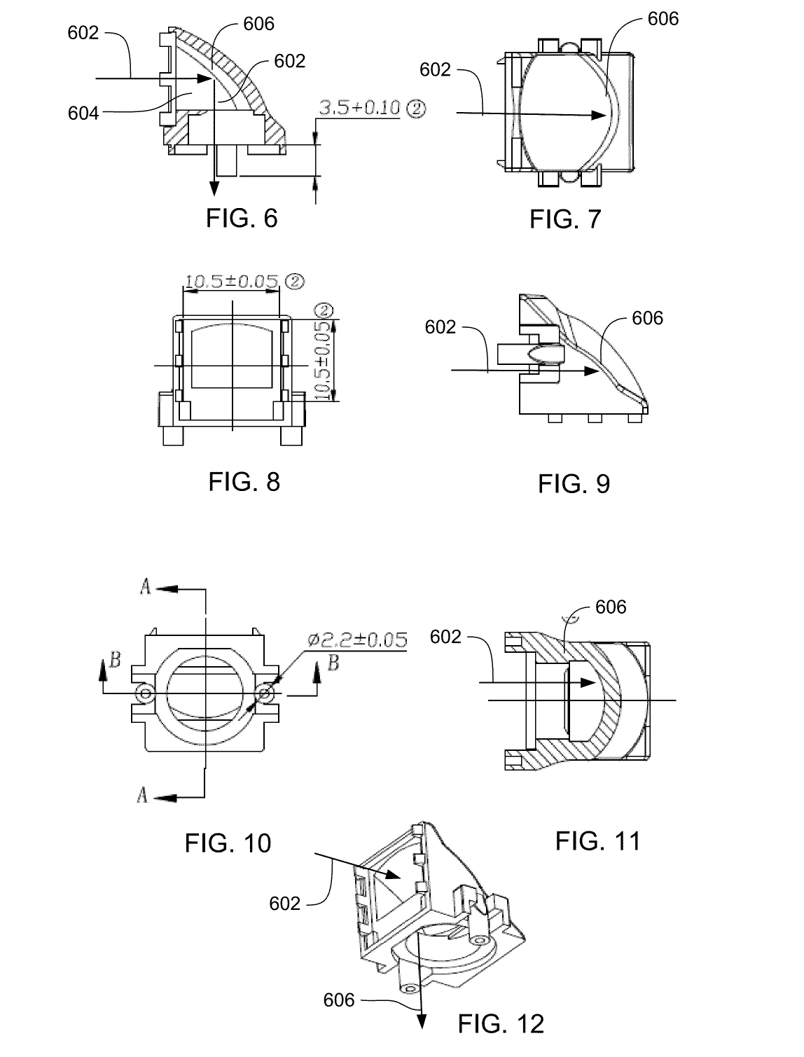

FIG. 6-12 are block diagrams of a sensor collector to guide electromagnetic energy to measure temperature, according to an implementation. FIG. 6 is a side cut-away view of the sensor collector to guide electromagnetic energy. The electromagnetic energy 602 enters the cavity 604 of the sensor collector and reflects off of the shroud 606 and through the bottom opening. The shroud 606 has in an inside surface that is concave. The shroud 606 is one example of the reflector 310 in FIG. 3. FIG. 7 is a top view of the sensor collector to guide electromagnetic energy. FIG. 8 is a front view of the sensor collector to guide electromagnetic energy. FIG. 9 is a side view of the sensor collector to guide electromagnetic energy. FIG. 10 is a bottom view of the sensor collector to guide electromagnetic energy. FIG. 11 is a top cut-away view of the sensor collector to guide electromagnetic energy. FIG. 12 is a bottom isometric view of the sensor collector to guide electromagnetic energy.

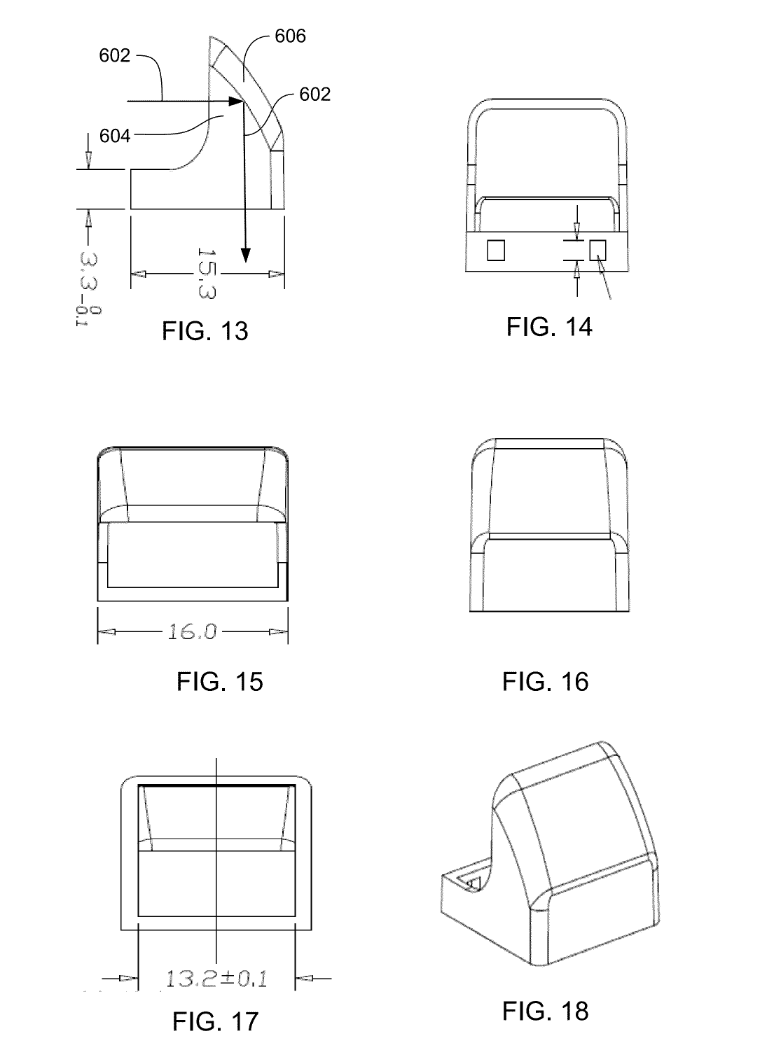

FIG. 13-18 are block diagrams of a shroud of a sensor collector to guide electromagnetic energy to measure temperature, according to an implementation. FIG. 13 is a side view of a shroud of a sensor collector to guide electromagnetic energy. The electromagnetic energy 602 enters the cavity 604 of the sensor collector and reflects off of the shroud 606 and through the bottom opening. FIG. 14 is a bottom view of a shroud of a sensor collector to guide electromagnetic energy. FIG. 15 is a front cut-away view of a shroud of a sensor collector to guide electromagnetic energy. FIG. 16 is a front view of a shroud of a sensor collector to guide electromagnetic energy. FIG. 17 is a front cut-away view of a shroud of a sensor collector to guide electromagnetic energy. FIG. 18 is a back top isometric view of a shroud of a sensor collector to guide electromagnetic energy.

Apparatus 600 includes the contact-thermometer 112 that is operably coupled to a first printed circuit board 602, a non-contact-thermometer 110 that is operably coupled to a second printed circuit board 604, the display device 104 that is operably coupled to the first printed circuit board 602 and the second printed circuit board 604, the button 106 that is operably coupled to the first printed circuit board 602 and the second printed circuit board 604 and the battery 108 that is operably coupled to the first printed circuit board 602 and the second printed circuit board 604. In apparatus 600, the display device 104, the button 106 and the battery 108 are shared, but each thermometer has a dedicated printed circuit board.

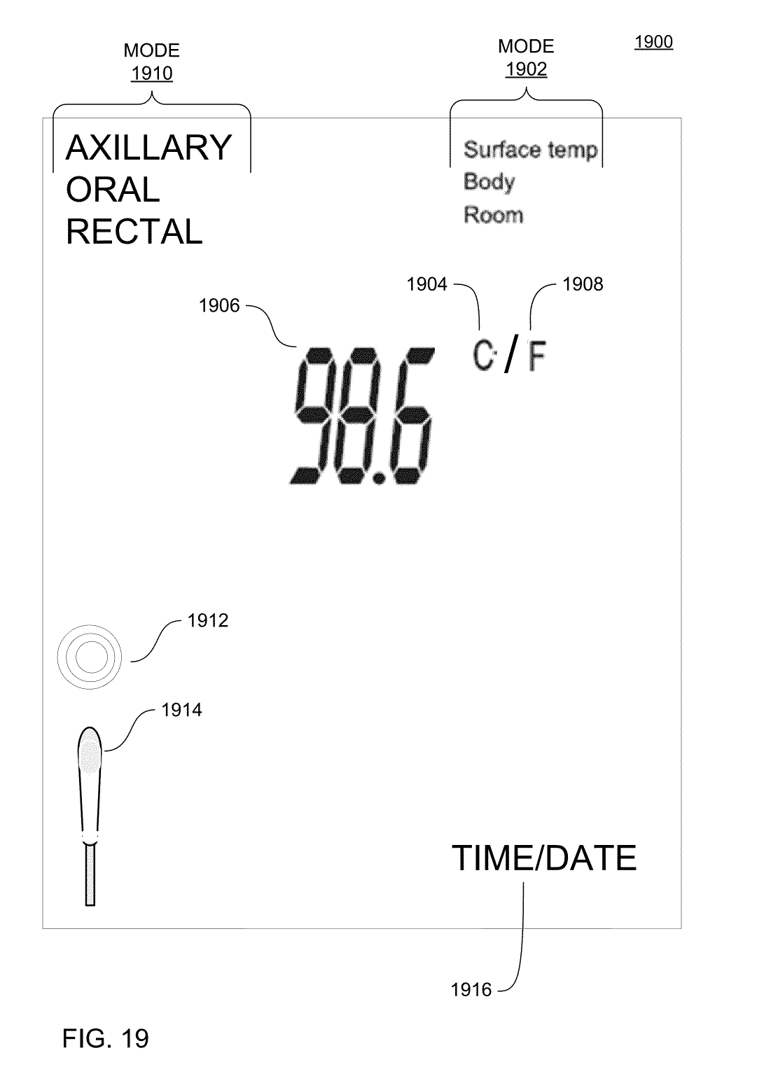

FIG. 19 is a representation of display that is presented on the display device of apparatus in FIG. 1-5, according to an implementation that manages both a non-contact-thermometer and a contact-thermometer.

Some implementations of display 1900 include a representation of three detection modes 1902, a first detection mode being detection and display of surface temperature, a second detection mode being detection and display of body temperature and a third detection mode being detection and display of room temperature.

Some implementations of display 1900 include a representation of Celsius 1904 that is activated when the apparatus is in Celsius mode.

Some implementations of display 1900 include a representation of a sensed temperature 1906.

Some implementations of display 1900 include a representation of Fahrenheit 1908 that is activated when the apparatus is in Fahrenheit mode.

Some implementations of display 1900 include a representation of a mode 1910 of site temperature sensing, a first site mode being detection of axillary surface temperature, a second site mode being detection of oral temperature and a third site mode being detection of rectal temperature.

Some implementations of display 1900 include a representation of a scanner mode 1912 that is activated when the sensed temperature 1906 is from a non-contact-thermometer 110.

Some implementations of display 1900 include a representation of a probe mode 1914 that is activated when the sensed temperature 1906 is from a contact-thermometer 112.

Some implementations of display 1900 include a representation of the current time/date 1916 of the apparatus.

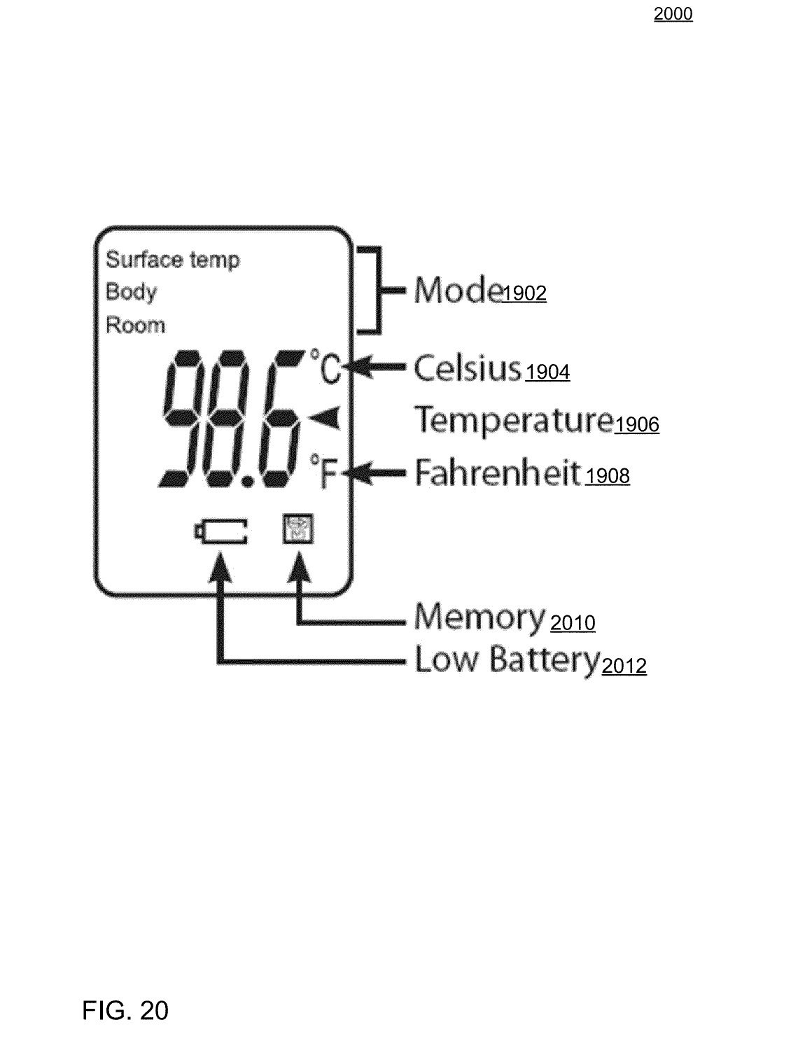

FIG. 20 is a representation of display 2000 that is presented on the display device of apparatus in FIG. 1-5, according to an implementation.

Some implementations of display 2000 include a representation of three detection modes 1902, a first detection mode being detection and display of surface temperature, a second detection mode being detection and display of body temperature and a third detection mode being detection and display of room temperature.

Some implementations of display 2000 include a representation of Celsius 1904 that is activated when the apparatus is in Celsius mode.

Some implementations of display 2000 include a representation of a temperature 1906.

Some implementations of display 2000 include a representation of Fahrenheit 1908 that is activated when the apparatus is in Fahrenheit mode.

Some implementations of display 2000 include a representation of memory 2010.

Some implementations of display 2000 include a representation of battery charge level 2012.

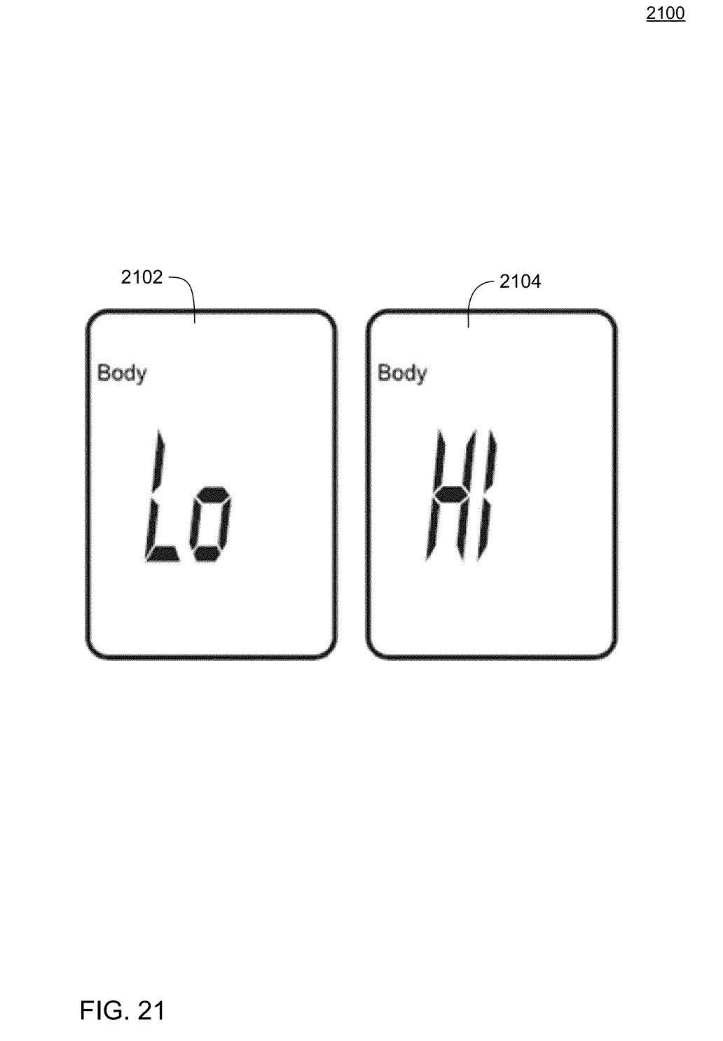

FIG. 21 is a representation of text displays 2100 that are presented on the display device of apparatus in FIG. 1-5, according to an implementation.

Some implementations of display 2100 include a text representation that a sensed body temperature 2102 is “Lo” as in “low”. Some implementations of display 2100 include a text representation that a sensed body temperature 2104 is “Hi” as in “high”.

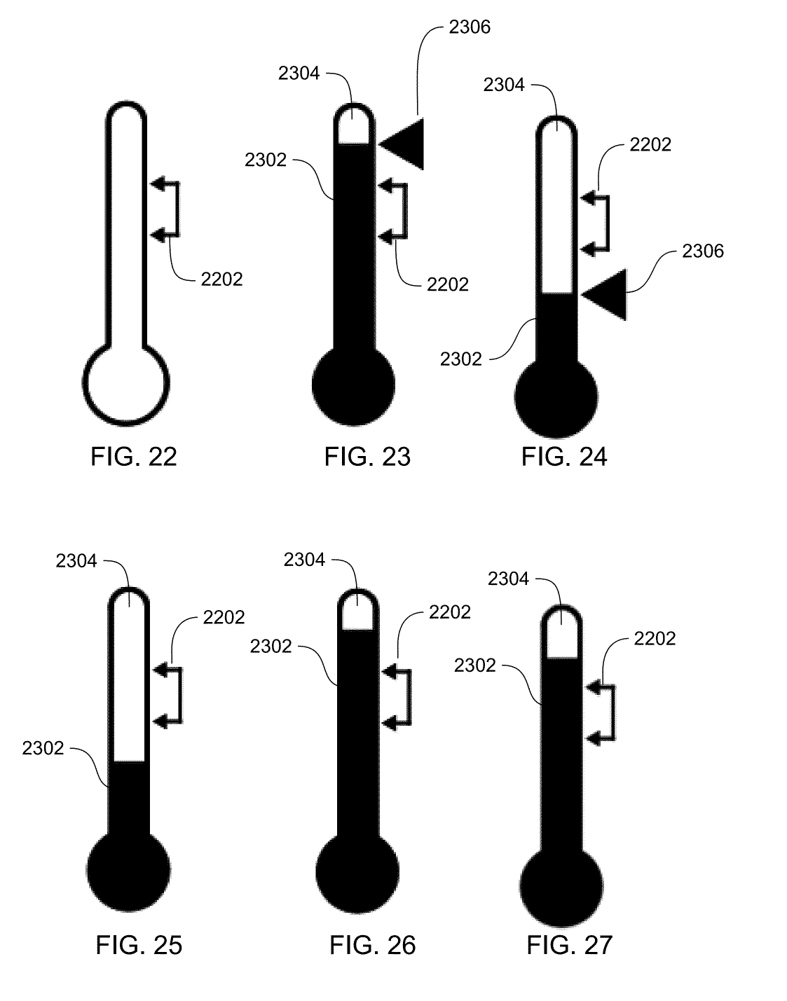

FIG. 9-14 are representations of graphical displays that are presented on the display device of apparatus in FIG. 1-5, according to implementations. The double-arrow bracket 2202 in FIG. 22-27 represents a general range of normal temperatures.

FIG. 22 is a graphical display that represents a state of having no sensed temperature. The empty thermometer in FIG. 22 indicates that no temperature sensing activity has completed.

FIG. 23 is a graphical display that represents a state of having sensed a high temperature. The thermometer in FIG. 23 having a contrasting color 2302 that is located above the general ranges of normal temperature indicates a higher than normal temperature. In FIG. 23-27, the contrasting color 2302 contrasts to the remainder 2304 of the interior of the thermometer image. In the example shown in FIG. 23-27, the contrasting color 2302 is black which contrasts with the white of the remainder 2304 of the interior of the thermometer image. FIG. 23 includes a pointer 2306 indicating the sensed temperature.

FIG. 24 is a graphical display that represents a state of having sensed a low temperature. The thermometer in FIG. 24 having only a contrasting color that is located below the general ranges of normal temperature indicates a lower than normal temperature. FIG. 24 includes a pointer 2306 indicating the sensed temperature.

FIG. 25 is a graphical display that represents a state of having sensed a low temperature. The thermometer in FIG. 25 having contrasting color located only below the general ranges of normal temperature indicates a lower than normal temperature.

FIG. 26 is a graphical display that represents a state of having sensed a high temperature. The thermometer in FIG. 26 having contrasting color that is located above the general ranges of normal temperature indicates a higher than normal temperature.

FIG. 27 is a graphical display that represents a state of having sensed a high temperature. The thermometer in FIG. 27 having contrasting color that is located above the general ranges of normal temperature indicates a higher than normal temperature.

Use Cases of Apparatus

In one example of use of the apparatus shown in FIG. 1-5, an operator performs a scan with the non-contact thermometer 110, the operator determines that a contact temperature is helpful or necessary and the operator performs a reading with a contact-thermometer 112. In another example of use of the apparatus shown in FIG. 1-5, the operator performs a reading with the contact-thermometer 112, the operator determines that a non-contact temperature is helpful or necessary and the operator performs a scan with the non-contact thermometer 110.

To perform a scan with the non-contact thermometer 110, the operator uses a button to select one three modes of the apparatus, 1) oral 2) rectal or 3) axillary. The operator pushes the scan button 106 to initiate a non-contact temperature scan. The apparatus displays the detected temperature that is calculated in reference to the selected mode.

To determine that a contact temperature is helpful or necessary, the operator reviews the temperature displayed by the apparatus and determines that a temperature reading using a different technique, such as either contact or non-contact) would be informative.

To perform a reading with the contact-thermometer 112, the operator removes a contact-thermometer 112 probe from a receiver and places a disposable probe cover over the contact-thermometer 112, and the operator inserts the probe of the contact-thermometer 112 into the mouth of a human or animal. The apparatus senses in increase in temperature through the contact-thermometer 112 and in response the apparatus starts a timer. After expiration of the timer, the apparatus displays on the display device 104 the sensed temperature at the time of the timer expiration and generates an audio alert and in response the operator removes the probe of the contact-thermometer 112 from the mouth of the human or animal, places the probe of the contact-thermometer 112 into the receiver and reads the displayed temperature on the display device 104.

### Method Implementations

In the previous section, apparatus of the operation of an implementation was described. In this section, the particular methods performed by apparatus 100, 200, 300, 400 and 500 of such an implementation are described by reference to a series of flowcharts.

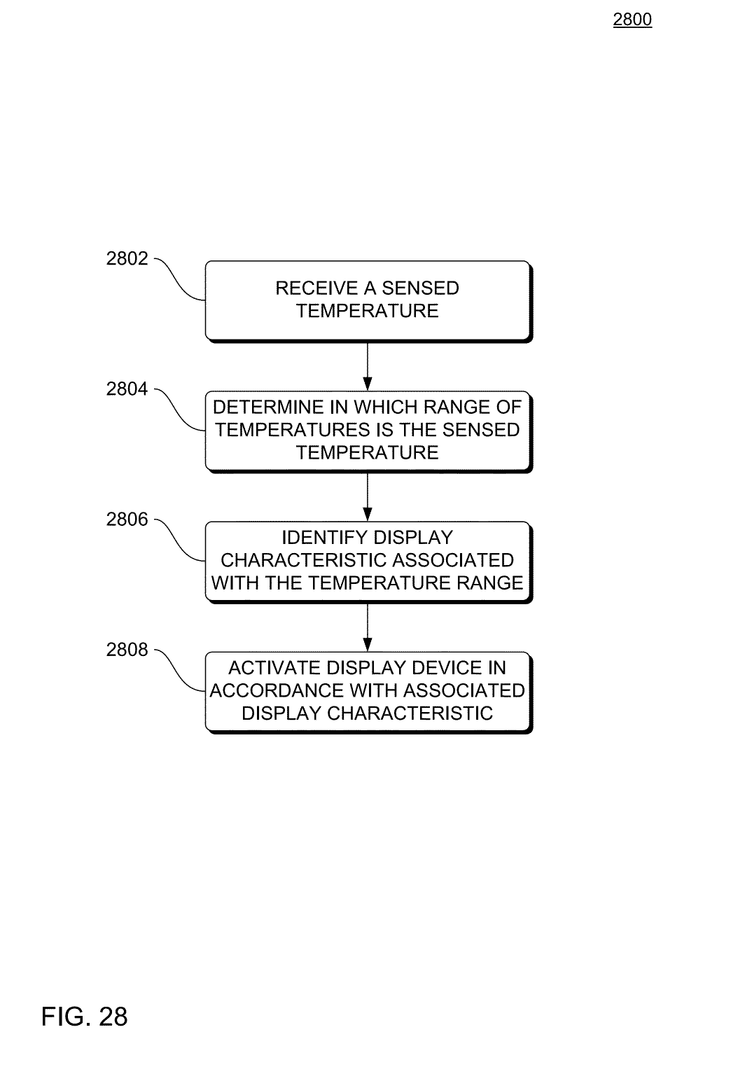

FIG. 28 is a flowchart of a method 2800 to display temperature color indicators, according to an implementation. Method 2800 provides color rendering in the display device 104 to indicate a general range of a sensed temperature.

Method 2800 includes receiving a sensed temperature, at block 2802. The sensed temperature can be received from the non-contact-thermometer 110 or the contact-thermometer 112, or the sensed temperature can be received from a printed circuit board that has adjusted a temperature in reference to either the site on the human or animal of the temperature sensing and or the ambient temperature detected in the vicinity of the apparatus performing the method 2800.

Method 2800 also includes determining in which of a plurality of ranges is the sensed temperature, at block 2804.

Method 2800 also includes identifying a display characteristic that is associated with the determined temperature range, at block 2806. In some implementations, the display characteristic is a color of text. In some implementations, the display characteristic is an image such as a commercial advertisement image.

Method 2800 also includes activating the display device 104 in accordance with the identified display characteristic, at block 2808. In the implementations in which the display characteristic is a color of text, method 2800 provides color rendering in the display device 104 to indicate the general range of the sensed temperature. The medical significance of the temperature is indicated by the displayed color. In the implementations in which the display characteristic is an image such as a commercial advertisement image, method 2800 provides advertising that is relevant to the medical condition of a patient.

In one implementation of a method to display temperature color indicators, according to an implementation of two colors, the method includes the non-contact-thermometer (such as 110 in FIG. 1) yields a sensed temperature and color changes of the display device (such as 104 in FIG. 1) are related to the sensed temperature, and the display device activates pixels in at least two colors, the colors being in accordance with the sensed temperature.

FIG. 16 is a flowchart of a method 1600 to display temperature color indicators, according to an implementation of three colors. Method 1600 provides color rendering in the display device 104 to indicate a general range of a sensed temperature.

Method 2900 includes receiving a sensed temperature, at block 1502. The sensed temperature can be received from the non-contact-thermometer 110 or the contact-thermometer 112, or the sensed temperature can be received from a printed circuit board that has adjusted a temperature in reference to either the site on the human or animal of the temperature sensing and or the ambient temperature detected in the vicinity of the apparatus performing the method 2900.

Method 2900 also includes determining whether or not the sensed temperature is in the range of 32.0° C. and 37.3° C., at block 2902. If the sensed temperature is in the range of 32.0° C. and 37.3° C., then the color is set to ‘green’ to indicate a temperature of no medical concern, at block 2904 and the background of the display device 104 is activated in accordance with the color, at block 2906.

If the sensed temperature is not the range of 32.0° C. and 37.3° C., then method 2900 also includes determining whether or not the sensed temperature is in the range of 37.4° C. and 38.0° C., at block 2908. If the sensed temperature is in the range of 37.4° C. and 38.0° C., then the color is set to ‘orange’ to indicate caution, at block 2910 and the background of the display device 104 is activated in accordance with the color, at block 2906.

If the sensed temperature is not the range of 37.4° C. and 38.0° C., then method 2900 also includes determining whether or not the sensed temperature is over 38.0° C., at block 2912. If the sensed temperature is over 38.0° C., then the color is set to ‘red’ to indicate alert, at block 2912 and the background of the display device 104 is activated in accordance with the color, at block 2906.

Method 2900 assumes that temperature is sensed in gradients of 10ths of a degree. Other temperature range boundaries are used in accordance with other gradients of temperature sensing.

In some implementations, some pixels in the display device 104 are activated as a green color when the sensed temperature is between 36.3° C. and 37.3° C. (97.3° F. to 99.1° F.), some pixels in the display device 104 are activated as an orange color when the sensed temperature is between 37.4° C. and 37.9° C. (99.3° F. to 100.2° F.), some pixels in the display device 104 are activated as a red color when the sensed temperature is greater than 38° C. (100.4° F.). In some implementations, the display device 104 is a backlit LCD screen (which is easy to read in a dark room) and some pixels in the display device 104 are activated (remain lit) for about 5 seconds after the button 104 is released. After the display device 104 has shut off, another temperature reading can be taken by the apparatus. The color change of the display device 104 is to alert the user of the apparatus of a potential increase of body temperature of the human or animal subject. Temperature reported on the display can be used for treatment decisions.

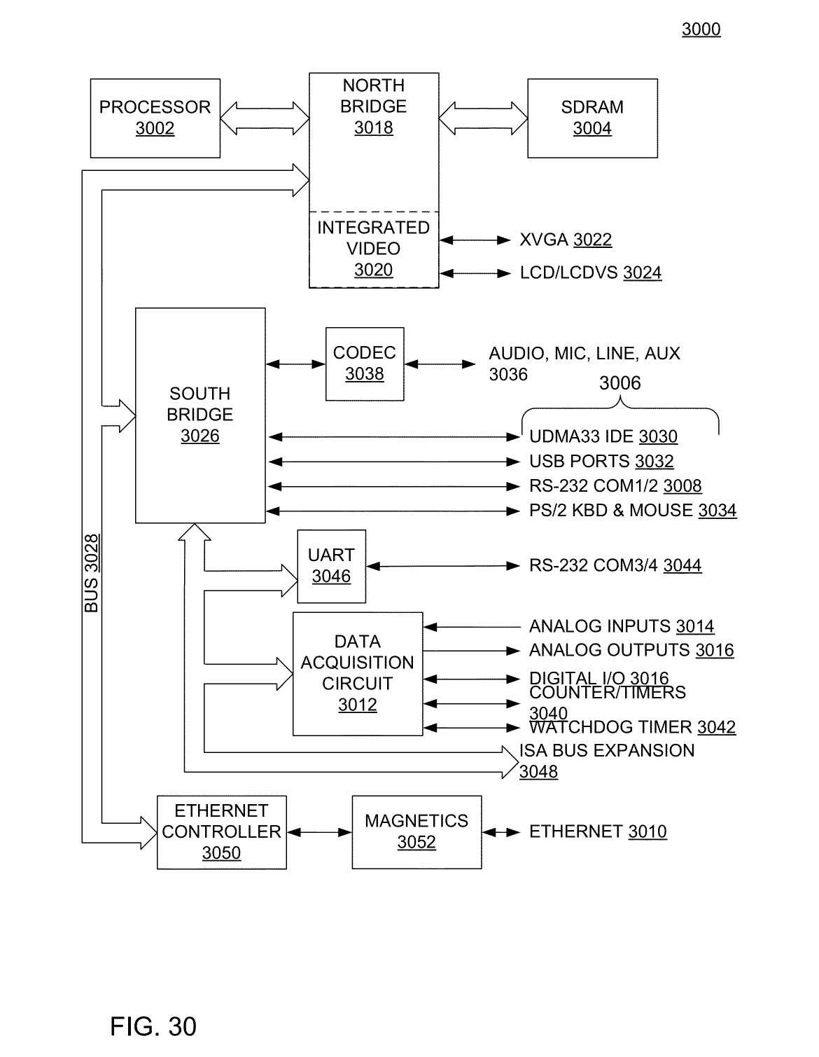

In some implementations, methods 1500-2900 are implemented as a sequence of instructions which, when executed by a processor 3002 in FIG. 30, cause the processor to perform the respective method. In other implementations, methods 1500-2900 are implemented as a computer-accessible medium having executable instructions capable of directing a processor, such as processor 3002 in FIG. 30, to perform the respective method. In varying implementations, the medium is a magnetic medium, an electronic medium, or an optical medium.

### Hardware and Operating Environment

FIG. 30 is a block diagram of a thermometer control computer 3000, according to an implementation. The thermometer control computer 3000 includes a processor (such as a Pentium III processor from Intel Corp. in this example) which includes dynamic and static ram and non-volatile program read-only-memory (not shown), operating memory 3004 (SDRAM in this example), communication ports 3006 (e.g., RS-232 3008 COM1/2 or Ethernet 3010), and a data acquisition circuit 3012 with analog inputs 3014 and outputs and digital inputs and outputs 3016.

In some implementations of the thermometer control computer 3000, the data acquisition circuit 3012 is also coupled to counter timer ports 3040 and watchdog timer ports 3042. In some implementations of the thermometer control computer 3000, an RS-232 port 3044 is coupled through a universal asynchronous receiver/transmitter (UART) 3046 to a bridge 3026.

In some implementations of the thermometer control computer 3000, the Ethernet port 3010 is coupled to the bus 3028 through an Ethernet controller 3050.

With proper digital amplifiers and analog signal conditioners, the thermometer control computer 3000 can be programmed to drive the display device 114. The sensed temperatures can be received by thermal sensors 110 and 112, the output of which, after passing through appropriate signal conditioners, can be read by the analog to digital converters that are part of the data acquisition circuit 3012. Thus the temperatures can be made adjusted for ambient temperature or the physical site of the human or animal that was examined for temperature on in as part of its decision-making software that acts to process and display sensed temperature.

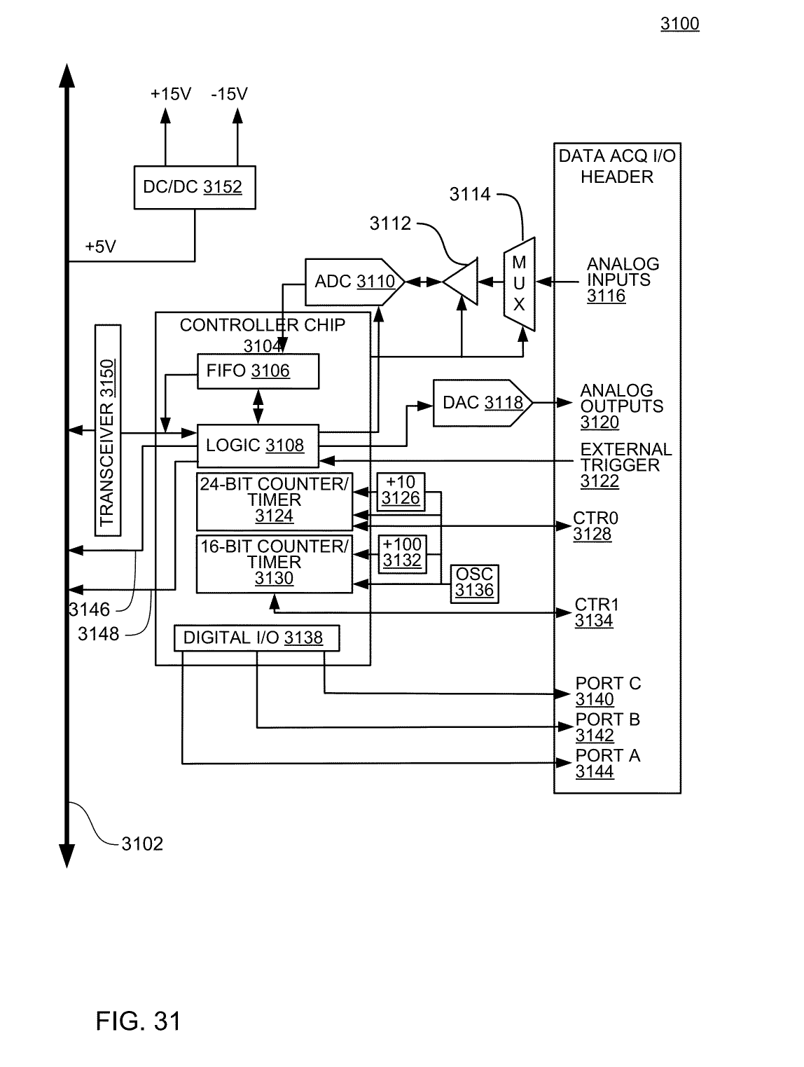

FIG. 31 is a block diagram of a data acquisition circuit 3100 of a thermometer control computer, according to an implementation. The data acquisition circuit 3100 is one example of the data acquisition circuit 3012 in FIG. 30 above. Some implementations of the data acquisition circuit 3100 provide 16-bit A/D performance with input voltage capability up to +/−10V, and programmable input ranges.

The data acquisition circuit 3100 can include a bus 3102, such as a conventional PC/104 bus. The data acquisition circuit 3100 can be operably coupled to a controller chip 3104. Some implementations of the controller chip 3104 include an analog/digital first-in/first-out (FIFO) buffer 3106 that is operably coupled to controller logic 3108. In some implementations of the data acquisition circuit 3100, the FIFO 3106 receives signal data from and analog/digital converter (ADC) 3110, which exchanges signal data with a programmable gain amplifier 3112, which receives data from a multiplexer 3114, which receives signal data from analog inputs 3116.

In some implementations of the data acquisition circuit 3100, the controller logic 3108 sends signal data to the ADC 3110 and a digital/analog converter (DAC) 3118. The DAC 3118 sends signal data to analog outputs. The analog outputs, after proper amplification, can be used to modulate coolant valve actuator positions. In some implementations of the data acquisition circuit 3100, the controller logic 3108 receives signal data from an external trigger 3122.

In some implementations of the data acquisition circuit 3100, the controller chip 3104 includes a digital input/output (I/O) component 3138 that sends digital signal data to computer output ports.

In some implementations of the data acquisition circuit 3100, the controller logic 3108 sends signal data to the bus 3102 via a control line 3146 and an interrupt line 3148. In some implementations of the data acquisition circuit 3100, the controller logic 3108 exchanges signal data to the bus 3102 via a transceiver 3150.

Some implementations of the data acquisition circuit 3100 include 12-bit D/A channels, programmable digital I/O lines, and programmable counter/timers. Analog circuitry can be placed away from the high-speed digital logic to ensure low-noise performance for important applications. Some implementations of the data acquisition circuit 3100 are fully supported by operating systems that can include, but are not limited to, DOS™, Linux™ RTLinux™, QNX™, Windows 98/NT/2000/XP/CE™, Forth™, and VxWorks™ to simplify application development.

### CONCLUSION

A combo-temperature sensor device is described. A technical effect of the combo-temperature sensor device is processing of sensed temperature data from both a non-contact-thermometer and a contact-thermometer. Although specific implementations are illustrated and described herein, it will be appreciated by those of ordinary skill in the art that any arrangement which is calculated to achieve the same purpose may be substituted for the specific implementations shown. This application is intended to cover any adaptations or variations.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future temperature sensing devices, different temperature measuring sites on humans or animals and new display devices.

The terminology used in this application meant to include all temperature sensors, processors and user environments and alternate technologies which provide the same functionality as described herein.

1. An apparatus to measure temperature, the apparatus comprising:
a housing;
at least one printed circuit board mounted in the housing;
a non-contact-thermometer operably coupled to the at least one printed circuit board, the non-contact-thermometer having an infrared sensor, the infrared sensor being operable to receive infrared energy via a pathway to the infrared sensor;
a lens positioned over the pathway to the infrared sensor, the lens having only right-angled edges, the lens being square in geometry, that is transverse to the pathway to the infrared sensor, wherein the pathway intersects the lens,
a reflector that is positioned at a 45 degree angle to the infrared sensor, the lens having a longitudinal axis that is transverse to a longitudinal axis of the infrared sensor, and the reflector being positioned at a 45 degree angle to the lens;
a waveguide in the housing between the lens and the at least one printed circuit board, the waveguide having geometry of a funnel, the funnel having a larger diameter at an opening of the waveguide than at an interior of the waveguide;
a display device operably coupled to the at least one printed circuit board;
a button operably coupled to the at least one printed circuit board; and
a battery operably coupled to the at least one printed circuit board.

2. The apparatus of claim 1, further comprising:
a contact-thermometer operably coupled to the at least one printed circuit board, yielding a sensed temperature.

3. The apparatus of claim 1, wherein the display device further comprises:
not more than one display device.

4. The apparatus of claim 1, wherein the battery further comprises:
not more than one battery.

5. The apparatus of claim 1, wherein the at least one printed circuit board further comprises:
not more than one printed circuit board, and
wherein the apparatus further comprises no other circuit board other than the one printed circuit board.

6. The apparatus of claim 1, wherein the at least one printed circuit board further comprises:
a first printed circuit board; and
a second printed circuit board.

7. The apparatus of claim 1, wherein the display device further comprises:
a liquid-crystal display device.

8. The apparatus of claim 1, wherein the at least one printed circuit board further comprises:
a microprocessor.

9. The apparatus of claim 1,
wherein the non-contact-thermometer yields a sensed temperature; and
wherein the display device activates pixels in at least two colors, the colors being in accordance with the sensed temperature.

10. An apparatus to measure temperature, the apparatus comprising:
a housing;
at least one printed circuit board mounted in the housing;
a non-contact-thermometer operably coupled to the at least one printed circuit board, the non-contact-thermometer having an electromagnetic sensor, the electromagnetic sensor being operable to receive electromagnetic energy via a pathway to the electromagnetic sensor, wherein the pathway has a geometry of a funnel, the funnel having a larger diameter at an opening of the pathway than at an interior of the pathway;
a lens positioned over the opening of the pathway to the electromagnetic sensor, the lens having at least one right-angled edge;
a display device operably coupled to the at least one printed circuit board; and
a button operably coupled to the at least one printed circuit board.

11. The apparatus of claim 10, wherein the lens further comprises:
the lens having only right-angled edges.

12. The apparatus of claim 10, wherein the lens further comprises:
the lens being square in geometry

13. The apparatus of claim 10,
wherein the lens is positioned transverse to the pathway to the electromagnetic sensor, and
wherein the pathway intersects the lens.

14. The apparatus of claim 13, wherein the apparatus further comprises:
a reflector that is positioned at a 45 degree angle to the electromagnetic sensor, the lens having a longitudinal axis that is transverse to a longitudinal axis of the electromagnetic sensor, and the reflector being positioned at a 45 degree angle to the lens.

15. The apparatus of claim 10, wherein the electromagnetic sensor further comprises:
an infrared temperature sensor.

16. The apparatus of claim 10,
wherein the non-contact-thermometer yields sensed temperature; and
wherein the display device activates pixels in at least two colors, the colors being in accordance with the sensed temperature.

17. An apparatus to measure temperature, the apparatus comprising:
at least one printed circuit board;
a non-contact-thermometer operably coupled to the at least one printed circuit board, the non-contact-thermometer having an electromagnetic sensor, the electromagnetic sensor being operable to receive electromagnetic energy via a waveguide electromagnetic sensor;
the waveguide having a geometry of a square funnel, the square funnel having four planer adjacent surfaces and having a larger diameter at an opening of the waveguide than at an interior of the waveguide, the four planar adjacent surfaces reflecting electromagnetic energy to the electromagnetic sensor that is about an energy level of the electromagnetic sensor outside the waveguide;
a display device operably coupled to the at least one printed circuit board;
a button operably coupled to the at least one printed circuit board;
a battery operably coupled to the at least one printed circuit board;
a contact-thermometer operably coupled to the at least one printed circuit board, yielding a sensed temperature;
a color display device operably coupled to the at least one printed circuit board, wherein the color display device activates pixels in at least two colors, the colors being in accordance with the sensed temperature.

18. The apparatus of claim 17,
wherein the color display device further comprises not more than one color display device, and
wherein the battery further comprises not more than one battery,
wherein the at least one printed circuit board further comprises not more than one printed circuit board, and
wherein the apparatus further comprises no other circuit board other than the one printed circuit board.

19. The apparatus of claim 17, wherein the non-contact-thermometer further comprises:
an infrared temperature sensor.

20. The apparatus of claim 17, wherein the waveguide further comprises:
the waveguide having only right-angled edges.
